(19) United States
(12) Patent Application Publication
(10) Pub. No.: US 2025/0376209 A1
(43) Pub. Date: Dec. 11, 2025

(54) ADJUSTABLE HANDLE SYSTEM

(71) Applicant: Kindled LLC, Atlanta, GA (US)

(72) Inventor: Brittany Remole Druin, Woodstock, GA (US)

(73) Assignee: Kindled LLC, Atlanta, GA (US)

(21) Appl. No.: 18/735,948

(22) Filed: Jun. 6, 2024

(51) Int. Cl. B62B 9/20; A61G 5/10

(52) U.S. Cl. CPC B62B 9/206; A61G 5/10

(57) ABSTRACT

An apparatus configured to attached to a wheeled transport device is disclosed. The apparatus may include a first clamping mechanism and a second clamping mechanism configured to removably attach to the wheeled transport device. The apparatus may include a first push arm and a second push arm extending vertically from respective first clamping mechanism and second clamping mechanism. The apparatus may further include a horizontal bar configured to connect the first push arm and the second push arm. The apparatus may further include a first swiveling mechanism disposed between the first clamping mechanism and the first push arm and a second swiveling mechanism disposed between the second clamping mechanism and the second push arm. The first swiveling mechanism and the second swiveling mechanism may be configured to swivel the first push arm and the second push arm relative to the first clamping mechanism and the second clamping mechanism respectively.

### TECHNICAL FIELD

The present disclosure relates to an adjustable handle system, and more specifically to an adjustable handle system for a wheeled transport.

### BACKGROUND

There exist transport devices configured to move a person or item from one place to another. Such transport devices include strollers, wheelchairs, shopping carts, lawn mowers, etc. A transport device typically includes wheels and a push handle that facilitates a user to move the transport device. The user may use the push handle to push the transport device and move the person or item from one place to another.

In some cases, the user may face difficulty in moving the transport device by using the push handle. For example, when the user is very tall, the user may have to bend to hold/push the push handle, which may cause inconvenience to the user. This is because the push handles are typically are designed according to an average-sized person and are non-customizable.

Thus, there is a need for an apparatus that may assist the user to conveniently push the transport device.

It is with respect to these and other considerations that the disclosure made herein is presented.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an environment in which techniques and structures for providing the systems and methods disclosed herein may be implemented.

FIG. 2 depicts a handle system in accordance with the present disclosure.

FIGS. 3A, 3B and 3C depict example embodiments of a removable coupling associated with a first handle part and a second handle part in accordance with the present disclosure.

FIG. 4 depicts a view of an attachment of a first handle part and a second handle part with a wheeled transport device in accordance with the present disclosure.

### DETAILED DESCRIPTION

### Overview

The present disclosure is directed to a handle system that may be removably attached to a wheeled transport device such as a stroller, a shopping cart, a wheelchair, a walker, a transport trolley, a tricycle, a lawn mower, etc. The handle system may be an adjustable handle system that may enable a user to adjust a handle height, a handle width, a handle angle relative to a wheeled transport longitudinal axis/ground, and/or the like.

The handle system may include clamping mechanisms or clamps to secure the handle system to the wheeled transport. The clamp may be a ring-shaped clamp having an interior surface and an exterior surface. In some aspects, the interior surface may be covered with rubber pads. The clamp may further include clamp handles disposed at the exterior surface. The clamp handles may enable the user to move the clamp between an open position and a closed position to attach/detach the handle system to/from the wheeled transport device.

The handle system may further include push arms that may extend vertically from the clamping mechanisms. The push arms may include a telescopic mechanism that may enable the user to adjust a push arm length. One end of the push arm may be connected to the clamping mechanism, and the other end may be connected to a horizontal bar. In some aspects, the horizontal bar may include a telescopic mechanism that may enable the user to adjust a horizontal bar width.

In some aspects, the horizontal bar may include a first part and a second part that may be removably connected to each other via a coupler. The first part may include a first hand grip and the second part may include a second hand grip. The first and second hand grips may be made of rubber or silicone. The first and second hand grips may include a magnet at a grip interior surface, which may enable magnetic coupling between the hand grips and the respective first part and second part. The first and second hand grips may be configured to slide on the respective first part and second part to cover or uncover the coupler.

The handle system may further include a swiveling mechanism that may enable swiveling of the push arms relative to the clamping mechanism. The swiveling mechanism may be a ball and socket connection that may enable rotation of the first part (with the first hand grip) and the second part (with second hand grip) between a first position and a second position. In the first position, the first part and the second part may be disposed in-line (and may be engaged via the coupler). In the second position, the first part and the second part may be disposed outwards (e.g., 90 degrees from the first position, and not engaged via the coupler). The first part and the second part may be engaged with each other and disposed in the first position to enable the user to use the handle system in a one-handle configuration. The first part and the second part may be disengaged from each other and disposed in the second position to enable the user to use the handle in a two-handle configuration.

The present disclosure discloses a handle system that may be customized according to user's requirements. The use of one-handle configuration and two-handle configuration enables the user to use the handle system according to the user's convenience/requirement, and use the handle system for different types of wheeled transport devices. For example, the user may use the one-handle configuration with a stroller and the two-handle configuration with a wheelchair.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

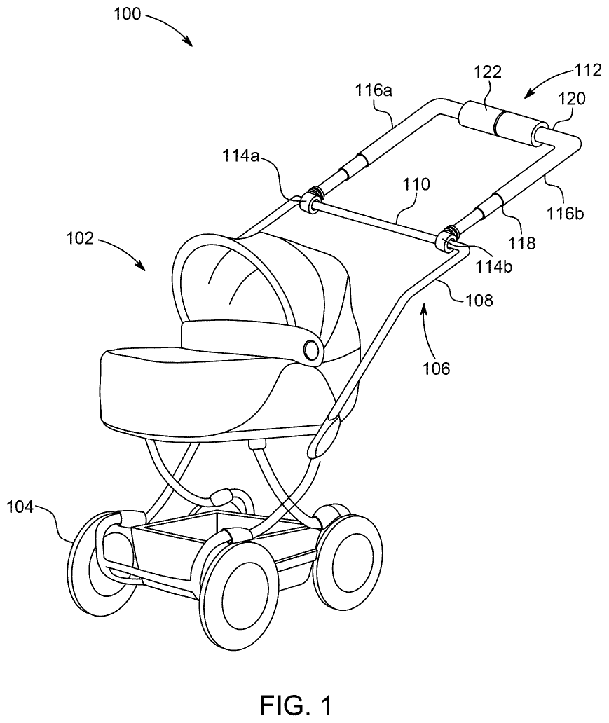

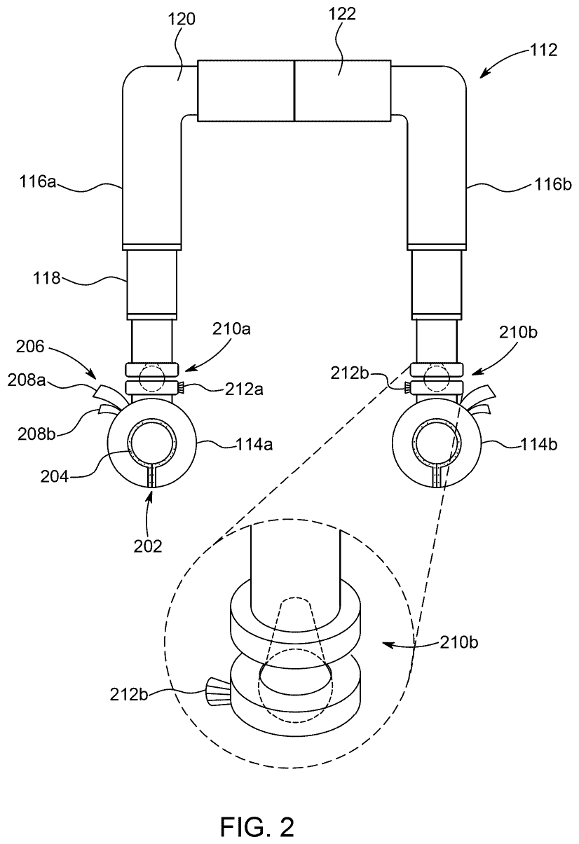

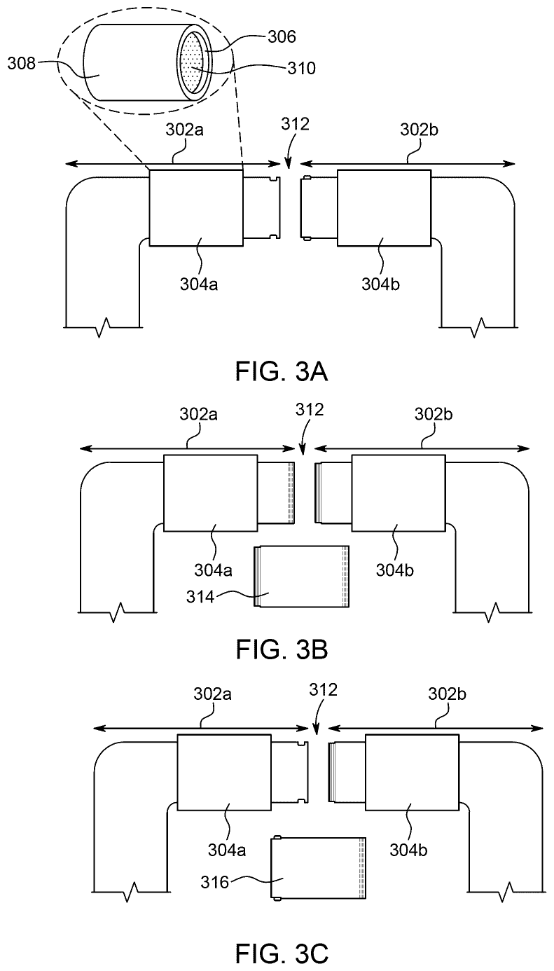

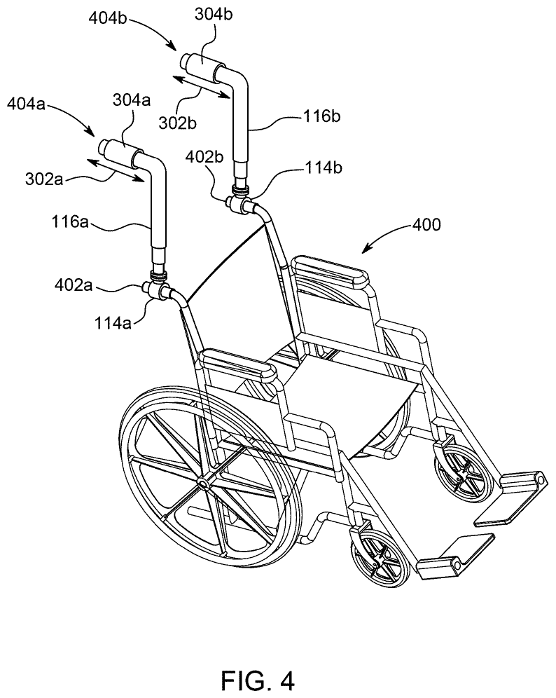

FIG. 1 depicts an environment 100 in which techniques and structures for providing the systems and methods disclosed herein may be implemented. FIG. 1 will be described in conjunction with FIGS. 2, 3A, 3B, 3C, and 4. FIG. 2 depicts a handle system. FIGS. 3A-3C depict example embodiments of a removable coupling associated with a first handle part and a second handle part. FIG. 4 depicts a view of an attachment of a first handle part and a second handle part with a wheeled transport device in accordance with the present disclosure.

The environment 100 may include a wheeled transport device 102 (wheeled transport 102) that may include, but is not limited to a stroller, a shopping cart, a wheelchair, a walker, a transport trolley, a tricycle, a lawn mower, etc. The wheeled transport 102 may include a plurality of components including, but not limited to, wheels 104 that facilitates wheeled transport movement, and an integrated handle 106 that may enable a user (not shown) to push the wheeled transport 102. The integrated handle 106 may include two integrated push arms 108 and an integrated horizontal bar 110 that connects proximal ends of the two integrated push arms 108. In some aspects, the integrated push arms 108 are substantially vertical or inclined at a predefined angle relative to a wheeled transport longitudinal axis (or a vertical axis that is perpendicular to ground).

The environment 100 may further include a handle system 112 (or a handle apparatus) that may be configured to be removably attached to the wheeled transport 102. The handle system 112 may act as an extension of the integrated handle 106, and may be used, for example, when a tall person/user is required to push the wheeled transport 102. In some aspects, the handle system 112 may be removably attached to the integrated horizontal bar 110 (e.g., in case of stroller, as shown in FIG. 1). Alternatively, the handle system 112 may be removably attached to other wheeled transport frame parts such as the integrated push arms 108. In further aspects, the handle system 112 may be removably attached to push handles of the wheeled transport 102 (e.g., in case of wheelchair, as shown in FIG. 4).

The handle system 112 may include a first clamping mechanism 114a and a second clamping mechanism 114b (collectively referred to as clamping mechanism 114). The clamping mechanism 114 may be used to secure or attach the handle system 112 with the wheeled transport 102. The clamping mechanism 114 may be removably connected to the wheeled transport 102 (e.g., to the integrated horizontal bar 110) to secure the handle system 112 with the wheeled transport 102. Further, the clamping mechanism 114 may be configured to axially rotate/move relative to the integrated horizontal bar 110.

In some aspects, the clamping mechanism 114 may include ring shaped clamps (as shown in FIG. 2). The clamp may include an openable end 202 that may be configured to open and close to attach/detach the clamp with the wheeled transport 102. Stated another way, the clamp may be configured to move between an open position and a closed position, via the openable end 202. When the openable end 202 is open, the clamping mechanism 114 may be in the open position, and when the openable end 202 is closed, the clamping mechanism 114 may be in the closed position. An example view of the closed position of the clamping mechanism 114 is shown in FIG. 2. A person ordinarily skilled in the art may appreciate that the clamping mechanism 114 may be of any other shape such as square, rectangular, etc.

In some aspects, a user may “push” the clamping mechanism 114 onto the integrated horizontal bar 110 when the user desires to connect the handle system 112 with the wheeled transport 102. When the user pushes the clamping mechanism 114 onto the integrated horizontal bar 110, the openable end 202 of the clamp moves from the closed positon to the open position (due to push force applied by the user), thereby enabling the clamp to encircle the integrated horizontal bar 110. The openable end 202 may move back to the closed position when the clamp fully encircles the integrated horizontal bar 110, thereby securely connecting the handle system 112 with the wheeled transport 102. In alternative or additional aspects, the user may use clamp handles (as described later below) to connect the clamping mechanism 114 to the integrated horizontal bar 110

The clamping mechanism 114 may be made of any material including, but not limited to, plastic, steel, aluminum, rubber, and/or the like. The clamping mechanism 114 may be of any dimensions. In some aspects, the clamping mechanism 114 dimensions (e.g., a clamp's internal diameter) may correspond to the integrated horizontal bar 110 dimensions (e.g., a horizontal bar 110 external diameter) or other wheeled transport frame parts dimensions to which the clamping mechanism 114 may be attached.

The clamping mechanism 114 may include an interior surface and an exterior surface opposite to the interior surface. The interior surface may be configured to contact the wheeled transport 102 to secure the handle system 112 with the wheeled transport 102. For example, the interior surface may contact the horizontal bar 110 exterior surface when the handle system 112 may be attached to the wheeled transport 102/integrated horizontal bar 110. In some aspects, the clamping mechanism 114 may include one or more rubber pads 204 (as depicted in FIG. 2) that may be disposed on the interior surface. The rubber pads 204 may be disposed such that the rubber pads 204 may completely cover the interior surface. In further aspects, the rubber pads 204 may be disposed at the openable end 202 edges. The rubber pads 204 at the openable end 202 edges may contact each other when the openable end 202 is closed or when the clamping mechanism 114 is in the closed position, as shown in FIG. 2.

In further aspects, the clamping mechanism 114 may include clamp handles 206 (as depicted in FIG. 2) that may be disposed at/attached to the clamping mechanism 114 exterior surface. The clamp handles 206 may be configured to move the clamping mechanism 114 between the closed position and the open position to enable the user to attach/detach the handle system 112 to/from the wheeled transport 102.

The clamp handles 206 may include a first clamp part 208a and a second clamp part 208b that may be placed adjacent to each other. The first clamp part 208a and the second clamp part 208b may be moved towards or away from each other to move the clamping mechanism 114 between the open position and the closed position. In some aspects, the clamping mechanism 114 may move to the open position when the user moves the first clamp part 208a and the second clamp part 208b away from each other. The user may then clamp or connect the clamping mechanism 114 (or clamp) on the wheeled transport 102. The clamping mechanism 114 may move to the closed position when the user moves the first clamp part 208a and the second clamp part 208b towards each other (to secure the clamping mechanism 114 to the wheeled transport 102). In alternative aspects, the clamping mechanism 114 may move to the open position when the user moves the first clamp part 208a and the second clamp part 208b towards each other,. Further, in this case, the clamping mechanism 114 may move to the closed position when the user moves the first clamp part 208a and the second clamp part 208b away each other.

In an exemplary embodiment, the clamping mechanism 114 may include a spring mechanism that may be configured to maintain the clamping mechanism 114 in the closed position. The user may press the clamp handles 206 against the spring tension to move the clamping mechanism to the open position.

The handle system 112 may further include a first push arm 116a and a second push arm 116b (collectively referred to as push arms 116). The push arms 116 may be connected to and extend vertically (or substantially vertically) from the respective clamping mechanisms 114. Each push arm 116 may include a distal end and a proximal end. The distal ends may be connected to the respective clamping mechanisms 114, and the proximal ends may be connected to a horizontal bar (e.g., a horizontal bar 120 described below). In some aspects, the push arms 116 may be disposed at a similar angle relative to the ground as the integrated push arm 108. Alternatively, the push arms 116 may be disposed at an angle different from the angle associated with the integrated push arms 108. The user may set the angle to a desired angle by axially rotating the clamping mechanism 114 on the integrated push arm 108. In some aspects, the push arms 116 may be integrated to the clamping mechanism 114. Alternatively, the push arms 116 may be removably connected to the clamping mechanism 114.

The push arms 116 may be made of any material. For example, the push arms 116 may be made of carbon fiber, aluminum, steel, plastic, and/or the like. In some aspects, the push arms 116 may be telescopic height adjustable arms having a telescopic mechanism 118 that may enable the user to adjust push arm 116 height/length. The user may use the telescopic mechanism 118 to adjust the push arm length to a desired length (e.g., by extending or retracting the push arm 116 via the telescopic mechanism 118). In some aspects, the push arms 116 may include a locking mechanism (not shown) configured to lock the push arm 116 (or the telescopic mechanism 118) at the desired length. The user may extend the push arms 116 to the desired length and lock the telescopic mechanism 118 at the desired length, to prevent sliding of the push arm 116 when the handle system 112 may be used to push the wheeled transport 102. The user may unlock the telescopic mechanism 118 to further adjust the push arm length.

The handle system 112 may further include a horizontal bar 120 that may connect the first push arm 116a and the second push arm 116b. In an exemplary aspect, the horizontal bar 120 may be connected to the proximal ends of the first push arm 116a and the second push arm 116b. Specifically, the horizontal bar 120 may be connected between the proximal ends of the first push arm 116a and the second push arm 116b. The horizontal bar 120 may be made of any material. As an example, the horizontal bar 120 may be made of ferrous metal.

In some aspects, the horizontal bar 120 may be telescopic width adjustable bar having a telescopic mechanism (not shown) that may enable the user to adjust a width of horizontal bar 120. The user may use the telescopic mechanism to adjust the horizontal bar width to a desired width (e.g., by extending or retracting the horizontal bar 120). In some aspects, the horizontal bar 120 may include a locking mechanism (not shown) configured to lock the horizontal bar 120 (or the telescopic mechanism) at the desired width, in the similar manner as described above for the push arms 116.

The horizontal bar 120 may include a hand grip 122. The hand grip 122 may be disposed at a horizontal bar 120 center/middle portion. The hand grip 122 may be a cylindrical ring (or hollow cylinder) configured to enclose the horizontal bar 120 middle portion. The hand grip 122 may include a grip interior surface (e.g., a grip interior surface 306 shown in FIG. 3A and described below) and a grip exterior surface (e.g., a grip exterior surface 308 shown in FIG. 3A and described below). The grip interior surface 306 may contact the horizontal bar 120 when the hand grip 122 encloses the horizontal bar 120 middle portion. In some aspects, the hand grip 122 may cover 25-70% of a horizontal bar length. The hand grip 122 that may be made of any material. In some aspects, the hand grip 122 may be made of rubber or silicone material, which may enable the user to use the handle system 112 (or push the wheeled transport 102) conveniently.

The horizontal bar 120 may include a first part 302a and a second part 302b that may be removably coupled with each other, as shown in FIGS. 3A-3C. In an exemplary embodiment, the first part 302a and the second part 302b may be identical to each other. For example, a first part 302a length may be same as a second part 302b length. In further aspects, the hand grip 122 may include a first hand grip 304a and a second hand grip 304b, as shown in FIGS. 3A-3C. In an exemplary embodiment, the first hand grip 304a and the second hand grip 304b may be identical to each other. The first hand grip 304a may be disposed on the first part 302a and the second hand grip 304b may be disposed on the second part 302b. In some aspects, the first hand grip 304a may be configured to slide horizontally on the first part 302a (or along a first part length) and the second hand grip 304b may be configured to slide horizontally on the second part 302b (or along a second part length). The first hand grip 304a and the second hand grip 304b may be configured to slide on the first part 302a and the second part 302b to cover or uncover a coupler or a connector 312 described below (e.g., to cover/uncover top and bottom surfaces of the connector 312).

Each of the first hand grip 304a and the second hand grip 304b may include a grip interior surface 306, and a grip exterior surface 308 opposite to the grip interior surface 306, as shown in FIG. 3A. The grip interior surface 306 may contact the horizontal bar 120 (e.g., respective first part 302a and the second part 302b) when the hand grip 122 encloses the horizontal bar 120 or the first part 302a and the second part 302b. In some aspects, the first hand grip 304a and the second hand grip 304b may include a magnet 310 that may be disposed at the grip interior surface 306. The magnet 310 may be configured to magnetically couple the first hand grip 304a and the second hand grip 304b with the first part 302a and the second part 302b respectively. The first part 302a and the second part 302b (i.e., the horizontal bar 120) may be a metal bar (e.g., made of a ferrous metal) that may be configured to magnetically couple with the first hand grip 304a and the second hand grip 304b respectively, via the magnet 310.

In an exemplary embodiment, the magnet 310 may cover the entire grip interior surface 306. In another embodiment, the magnet 310 may cover a grip interior surface 306 portion (e.g., 10-90% portion along a grip interior surface length). In yet another embodiment, the magnet 310 may be disposed in a predetermined pattern on the entire grip interior surface 306. The magnet 310 may be disposed such that the user may conveniently slide the first hand grip 304a and the second hand grip 304b over the first part 302a and the second part 302b respectively. Further, a magnetic strength associated with the magnet 310 may be such that the user may easily slide the first hand grip 304a and the second hand grip 304b over the first part 302a and the second part 302b respectively.

The first part 302a and the second part 302b may be removably coupled to each other via a connector or coupler 312. In one exemplary aspect, the connector or coupler 312 may be a buckle connector, as shown in FIG. 3A. The buckle connector may include a male connector that may be connected to one part (first part 302a/second part 302b) and a female connector that may be connected to the other part (second part 302b/first part 302a). The male connector may be configured to engage with the female connector to enable attachment/detachment of the first part 302a to/from the second part 302b.

In another exemplary aspect, the connector or coupler 312 may be a threaded coupler that may removably connect the first part 302a with the second part 302b, as shown in FIG. 3B. In some aspects, the threaded coupler may be a cylindrical coupler with threads. For example, the first part 302a may include a female coupler having threads at an outer surface, and the second part 302b may include a male coupler having threads at an inner surface. The male coupler and the female coupler may be configured to engage/disengage with each other to attach/detach the first part 302a with the second part 302b. In some aspects, the male coupler and the female coupler may be configured to attach with one or more additional threaded couplers 314 to increase the horizontal bar 120 width, if desired by the user.

In yet another exemplary aspect, the connector or coupler 312 may be a combination of the buckle connector and the threaded coupler, as shown in FIG. 3C. The details of the buckle connector and the threaded coupler are described above in conjunction with FIGS. 3A and 3B. Specifically, in this case, the first part 302a may be connected to the female buckle connector and the second part 302b may include a male threaded coupler. The female buckle connector and the male threaded coupler may engage with a coupler 316 having the male buckle connector at one end and female threaded coupler at another end.

A person ordinarily skilled in the art may appreciate that the first part 302a and the second part 302b may be removably connected to each other via any other mechanism/connector as well, and is not limited to the aspects described above and shown in FIGS. 3A-3C. For example, the first part 302a and the second part 302b may removably connected to each other via a magnetic connector. In this case, the first part 302a and the second part 302b may include magnets at the edges of the first part 302a and the second part 302b, which may enable magnetic connection between the first part 302a and the second part 302b. In other aspects, the first part 302a may include the magnet and the second part 302b may include a ferrous material configured to magnetically couple with the magnet.

The handle system 112 may further include a first swiveling mechanism 210a and a second swiveling mechanism 210b (collectively referred to as swiveling mechanism 210) that may enable rotation of the first push arm 116a and the second push arm 116b along their respective longitudinal axis. The first push arm 116a and the second push arm 116b may be configured to rotate in a clockwise direction and/or a counter-clockwise direction via the swiveling mechanism 210. In some aspects, the swiveling mechanism 210 may be disposed in proximity to the distal ends of the push arms 116. Specifically, the swiveling mechanism 210 may be disposed between the push arms 116 and the respective clamping mechanisms 114, which enables the push arms 116 to rotate/swivel at a predetermined angle relative to the clamping mechanisms 114. In some aspects, the predetermined angle may be in a range of 0-90 degrees. In another aspect, the predetermined angle may be in a range of 0-360 degrees.

In some aspects, the swiveling mechanism 210 may include a ball and socket connection that enables push arm 116 swiveling. The ball and socket connection enables pivoting and rotation of the push arms 116 relative to the clamping mechanisms 114 (or the wheeled transport 102). A person ordinarily skilled in the art may appreciate that the swiveling mechanism 210 may include any other connection as well to enable swiveling of the push arms 116 relative to the clamping mechanism 114.

In further aspects, the swiveling mechanism 210 may include a locking mechanism 212a, 212b configured to lock the position of the push arms 116 relative to the clamping mechanisms 114. The locking mechanism 212 may be a dialer that the user may use to prevent unnecessary push arm 116 rotation. The swiveling mechanism 210 may be made of any material including, but not limited to, plastic, steel, rubber, aluminum, etc.

The handle system 112 may be configured to operate in various configurations such as a one-handle configuration and a two-handle configuration. In the one-handle configuration, the first part 302a may be engaged/connected with the second part 302b, and the first hand grip 304a may contact the second hand grip 304b. In the one-handle configuration, the first hand grip 304a and the second hand grip 304b may be disposed at the horizontal bar 120 center/middle portion, as shown in FIG. 2. In addition, in the one-handle configuration, the first part 302a and the second part 302b may be disposed in-line or aligned with each other (referred to as a “first position”). In the one-handle configuration, the clamping mechanisms 114, the push arms 116, and the horizontal bar 120 (including the first part 302a and the second part 302b) may form an inverted U-shaped handle (similar to the integrated push handle 106 shown in FIG. 1).

In the two-handle configuration, the first part 302a may be disengaged with the second part 302b, and the first hand grip 304a may be separated from the second hand grip 304b, as shown in FIG. 4. In the two-handle configuration, the inverted U-shaped handle (of the one-handle configuration) is divided to form two inverted L-shaped handles. The two inverted L-shaped handles may be rotated 90 degrees outwards (via the swiveling mechanism 210) to move the first part 302a and the second part 302b from the first position to a second position (similar to a position of push handles 402a, 402b of a wheelchair 400 shown in FIG. 4, described below). In the second position, the first part 302a and the second part 302b are not in-line or aligned with each other, and may face the user when the user may be pushing the wheeled transport 102.

Specifically, FIG. 4 depicts a wheelchair 400 having a first push handle 402a and a second push handle 402b. The first push handle 402a may be connected to a first handle 404a (of the handle system 112) and the second push handle 402b may be connected to a second handle 404b (of the handle system 112). The first handle 404a and the second handle 404b may be two parts of the handle system 112 (e.g., when the handle system 112 operates in the two-handle configuration). The first handle 404a and the second handle 404b may be separated from each other (e.g., by disengaging the connector or coupler 312). The first handle 404a may include the first clamping mechanism 114a, the first push arm 116a, the first part 302a, and the first hand grip 304a. The second handle 404b may include the second clamping mechanism 114b, the second push arm 116b, the second part 302b, and the second hand grip 304b.

In operation, the user may attach the handle system 112 (e.g., in the one-handle configuration) to the wheeled transport 102 using the clamping mechanism 114. To attach the handle system 112 with the wheeled transport 102, the user may operate the clamp handles 206 to move the clamping mechanism 114 (e.g., the first clamping mechanism 114a and the second clamping mechanism 114b) to the open position. When the clamping mechanism 114 may be in the open position, the user may clamp the clamping mechanism 114 on the integrated horizontal bar 110. Stated another way, the user may engage the clamping mechanism 114 with the wheeled transport 102 when the clamping mechanism 114 may be in the open position. When the clamping mechanism 114 may be engaged with the wheeled transport 102, the user may move the clamping mechanism 114 to the closed position, and/or may lock the clamping mechanism 114.

Once the handle system 112 is attached to the wheeled transport 102, the user may adjust the push arm 116 height/length to the desired length, via the telescopic height adjustable arms. In addition, the user may adjust the width of the horizontal bar 120 to the desired width. Further, the user may set the inclination angle of the push arms 116 relative to wheeled transport longitudinal axis (e.g., by axially rotating the clamping mechanism 114 relative the integrated horizontal bar 110).

In some aspects, the user may desire to use the handle system 112 in another configuration, e.g., the two-handle configuration described above. In order to switch the configuration of the handle system 112 from the one-handle configuration to the two-handle configuration, the user may slide the first hand grip 304a and the second hand grip 304b to uncover the connector or coupler 312 (connected to the first part 302a and the second part 302b). When the connector or coupler 312 is uncovered, the user may disengage the first part 302a from the second part 302b. For example, the user may disengage the first part 302a and the second part 302b by disengaging the female connector from the male connector. Once the first part 302a and the second part 302b are disengaged, the user may rotate the first part 302a and the second part 302b to move the first part 302a and the second part 302b to the second position. Thereafter, the user may lock the push arm 116 rotation via the locking mechanism 212.

When the user desires to switch the configuration of the handle system 112 from the two-handle configuration back to the one-handle configuration, the user may rotate the first part 302a and the second part 302b to move the first part 302a and the second part 302b to the first position. When the first part 302a and the second part 302b are moved to the first position (i.e., when the first part 302a may be aligned with the second part 302b), the user may use the connector or coupler 312 to engage/connect the first part 302a and the second part 302b. When the first part 302a and the second part 302b are connected, the user may slide the first hand grip 304a and the second hand grip 304b to cover the connector or coupler 312 to operate the handle system 112 in the one-handle configuration.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc., should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. An apparatus comprising:
a first clamping mechanism and a second clamping mechanism configured to removably attach to a wheeled transport device;
a first push arm and a second push arm extending vertically from respective first clamping mechanism and second clamping mechanism;
a horizontal bar configured to connect the first push arm and the second push arm; and
a first swiveling mechanism disposed between the first clamping mechanism and the first push arm and a second swiveling mechanism disposed between the second clamping mechanism and the second push arm, wherein the first swiveling mechanism and the second swiveling mechanism are configured to swivel the first push arm and the second push arm relative to the first clamping mechanism and the second clamping mechanism respectively.

2. The apparatus of claim 1, wherein the first push arm and the second push arm are telescopic height adjustable arms.

3. The apparatus of claim 1, wherein each of the first swiveling mechanism and the second swiveling mechanism comprises ball and socket connection.

4. The apparatus of claim 1, wherein the horizontal bar comprises a first part and a second part that are removably connected to each other.

5. The apparatus of claim 4, wherein the first part and the second part are removably connected via a buckle connector, and wherein the buckle connector comprises a female connector and a male connector.

6. The apparatus of claim 4, wherein the first part and the second part are removably connected via a threaded coupler.

7. The apparatus of claim 4, wherein the horizontal bar further comprises a first hand grip and a second hand grip, and wherein the first hand grip is disposed on the first part and the second hand grip is disposed on the second part.

8. The apparatus of claim 7, wherein each of the first hand grip and the second hand grip comprises a hand grip interior surface and a hand grip exterior surface.

9. The apparatus of claim 8, wherein the hand grip interior surface comprises a magnet configured to magnetically couple the first hand grip and the second hand grip with the horizontal bar.

10. The apparatus of claim 9, wherein the horizontal bar comprises a metal bar.

11. The apparatus of claim 1, wherein the horizontal bar is a telescopic width adjustable bar.

12. The apparatus of claim 1, wherein each of the first push arm and the second push arm comprises a distal end and a proximal end, and wherein the distal end is attached to the first clamping mechanism and the second clamping mechanism and the proximal end is connected to the horizontal bar.

13. The apparatus of claim 12, wherein the first swiveling mechanism and the second swiveling mechanism are disposed in proximity to the distal end.

14. The apparatus of claim 1, wherein each of the first clamping mechanism and the second clamping mechanism comprises a ring shaped clamp, and wherein the ring shaped clamp comprises a clamp interior surface and a clamp exterior surface.

15. The apparatus of claim 14, wherein each of the first clamping mechanism and the second clamping mechanism comprises a first rubber pad attached to the clamp interior surface.

16. The apparatus of claim 15, wherein each of the first clamping mechanism and the second clamping mechanism comprises an openable end, and wherein a second rubber pad is disposed at edges of the openable end.

17. The apparatus of claim 14, wherein each of the first clamping mechanism and the second clamping mechanism comprises a clamp handle attached to the clamp exterior surface, and wherein the clamp handle is configured to attach or detach the first clamping mechanism and the second clamping mechanism to the wheeled transport device.

18. An apparatus comprising:
a first clamping mechanism and a second clamping mechanism configured to removably attach to a wheeled transport device;
a first push arm and a second push arm extending vertically from respective first clamping mechanism and second clamping mechanism;
a horizontal bar configured to connect the first push arm and the second push arm, wherein the horizontal bar comprises a first part and a second part that are removably connected to each other; and
a first swiveling mechanism disposed between the first clamping mechanism and the first push arm and a second swiveling mechanism disposed between the second clamping mechanism and the second push arm, wherein the first swiveling mechanism and the second swiveling mechanism are configured to swivel the first push arm and the second push arm relative to the first clamping mechanism and the second clamping mechanism respectively.

19. The apparatus of claim 18, wherein each of the first swiveling mechanism and the second swiveling mechanism comprises ball and socket connection.

20. An apparatus comprising:
a first clamping mechanism and a second clamping mechanism configured to removably attach to a wheeled transport device;
a first push arm and a second push arm extending vertically from respective first clamping mechanism and second clamping mechanism, wherein the first push arm and the second push arm are telescopic height adjustable arms;
a horizontal bar configured to connect the first push arm and the second push arm; and
a first swiveling mechanism disposed between the first clamping mechanism and the first push arm and a second swiveling mechanism disposed between the second clamping mechanism and the second push arm, wherein the first swiveling mechanism and the second swiveling mechanism are configured to swivel the first push arm and the second push arm relative to the first clamping mechanism and the second clamping mechanism respectively.
